(19) United States
(12) Patent Application Publication
(10) Pub. No.: US 2026/0120569 A1
(43) Pub. Date: Apr. 30, 2026

(54) Method and Apparatus for Detecting Road Construction

(71) Applicants: Hyundai Motor Company, Seoul (KR); Kia Corporation, Seoul (KR)

(72) Inventor: Jeung Sik Hong, Hwaseong-Si (KR)

(21) Appl. No.: 19/227,129

(22) Filed: Jun. 3, 2025

(30) Foreign Application Priority Data
Oct. 29, 2024 (KR) 10-2024-0149595

(51) Int. Cl. G08G 1/16; G08G 1/01

(52) U.S. Cl. CPC G08G 1/164; G08G 1/0108; G08G 1/0133; G08G 1/0145; G08G 1/166

(57) ABSTRACT

A vehicle and a control method thereof are provided. A method may include: receiving, by at least one processor from a sensor disposed along a road, one or more sensor values measured by the sensor; storing the one or more sensor values in memory; monitoring, based on the one or more stored sensor values, a variation in distance over time; determining, based on a change in the one or more sensor values, that no road construction or obstacle has been detected; defining a sensor section, where the change in the one or more sensor values has been detected for a longer than a threshold time duration, as a road construction section or an obstacle section and generating, based on the defined sensor section, section information; and transmitting, to a base station, the section information via a wireless transceiver.

### RELATED APPLICATIONS

This application claims the benefit of and priority to Korea Patent Application No. 10-2024-0149595, filed on October 29, 2024, the entire disclosure of which is hereby incorporated herein by reference in its entirety.

### TECHNICAL FIELD

The present disclosure relates to a method and device for autonomous driving control of vehicles, and more specifically, detecting obstacles on the roadway by autonomous vehicles.

### BACKGROUND

The content described below merely provides background information related to the present disclosure and does not constitute prior art.

Autonomous vehicles may use sensors that are built into the vehicle to detect the surrounding environment of the road. Autonomous vehicles may detect lanes, other vehicles, and obstacles using these sensors. Autonomous vehicles may use the information about the detected objects to warn the driver or control the vehicle. For efficient driving of autonomous vehicles, it is important to obtain accurate information about the surrounding environment.

Information about any ongoing road constructions may be obtained from reports that are provided by construction operators. The road construction information may include, for example, the location, the scope, and the duration of a given construction project. Autonomous vehicles may use road construction information to avoid or navigate through road construction zones.

Accurate recognition of road construction sites can have a significant effect on the safe operation of autonomous vehicles. However, the road construction information may contain errors or discrepancies between a reported construction location and an actual construction location. The difference in the spatial discrepancy between the reported location of a construction site and the actual location may range, for example, from several meters to several kilometers. In addition, some road construction information may be unreliable for use in autonomous driving control because the start and end times for a construction project may not have been accurately reported, or both the preparation time before the start of the construction project and the clean-up time to remove the equipment after the completion of the project may be unpredictable.

### SUMMARY

The main purpose of the present disclosure is to provide a method and apparatus capable of providing accurate road construction information to an autonomous vehicle using a road sensor.

The problems to be solved by the present invention are not limited to the problems mentioned above, and other problems not mentioned will be clearly understood by those skilled in the art from the description below.

According to one or more example embodiments of the present disclosure, by using road sensor information, information on the start and end of construction can be obtained directly without having to rely on reports from construction companies.

One or more example embodiments of the present disclosure allow obtaining road construction information and obstacle information on the road in real time by using sensor information on the road.

The effects of the present disclosure are not limited to the effects mentioned above, and other effects not mentioned will be clearly understood by those skilled in the art from the description below.

According to one or more example embodiments of the present disclosure, a method may include: receiving, by at least one processor from a sensor disposed along a road, one or more sensor values measured by the sensor; storing the one or more sensor values in memory; monitoring, based on the one or more stored sensor values, a change in the one or more sensor values; determining, based on a change in the one or more sensor values, that no road construction or obstacle has been detected; defining a sensor section, where the change in the one or more sensor values has been detected for a longer than a threshold time duration, as a road construction section or an obstacle section and generating, based on the defined sensor section, section information; and transmitting, to a base station, the section information via a wireless transceiver.

Monitoring may include determining, based on a time of the change, whether a vehicle is passing on the road or whether a road construction or an obstacle is present on the road.

Monitoring may include expanding a monitoring range by additionally monitoring with one or more sensors outside of the sensor section.

The one or more sensors outside of the sensor section may include at least one of: one or more sensors disposed along the road; or one or more vehicles traveling on the road.

Monitoring may include determining, based on the one or more sensor values returning to a baseline value of the sensor, that the road construction is complete or the obstacle is removed.

The method may further include: based on the one or more sensor values returning to the baseline value of the sensor, transmitting, to the base station, an indication of completion of the road construction or removal of the obstacle.

Determining may include determining whether a variation in the one or more sensor values, indicating presence of the road construction is due to a failure of the sensor.

Determining may include determining whether a variation in the one or more sensor values is due to a traffic light or a traffic congestion.

Determining may include determining whether a congested lane of the road corresponds to a highway ramp.

According to one or more example embodiments of the present disclosure, an apparatus may include: at least one processor; and memory. The memory may store instructions that, when executed by the at least one processor, cause the apparatus to: receive, from a sensor disposed along a road, a one or more sensor values measured by the sensor; store, in the memory, the one or more sensor values; monitor, based on the one or more stored sensor values, a variation in distance over time; determine, based on a change in the one or more sensor values, that no road construction or obstacle has been detected; define a sensor section, where the change in the one or more sensor values has been detected for longer than a threshold time duration, as a road construction section or an obstacle section and generate, based on the defined sensor section, section information; and transmit, to a base station, the section information via a wireless transceiver.

The instructions, when executed by the at least one processor, may cause the apparatus to monitor the change by determining, based on a time of the change, whether a vehicle is passing on the road or whether a road construction or an obstacle is present on the road.

The instructions, when executed by the at least one processor, may cause the apparatus to monitor the change by expanding a monitoring range by additionally monitoring with one or more sensors outside of the sensor section.

The one or more sensors outside of the sensor section may include at least one of: one or more sensors disposed along the road; or one or more vehicles traveling on the road.

The instructions, when executed by the at least one processor, may cause the apparatus to monitor the change by determining, based on the one or more sensor values returning to a baseline value of the sensor, that the road construction is complete or the obstacle is removed.

The instructions, when executed by the at least one processor, may further cause the apparatus to: based on the one or more sensor values returning to the baseline value of the sensor, transmit, to the base station, an indication of completion of the road construction or a removal of the obstacle.

The instructions, when executed by the at least one processor, may cause the apparatus to determine that no road construction or obstacle has been detected, by: determining whether a variation in the one or more sensor values, indicating presence of the road construction is due to a failure of the sensor.

The instructions, when executed by the at least one processor, cause the apparatus to determine that no road construction or obstacle has been detected, by: determining whether a variation in the one or more sensor values is due to a traffic light or a traffic congestion.

The instructions, when executed by the at least one processor, may cause the apparatus to determine that no road construction or obstacle has been detected, by: determining whether a congested lane of the road corresponds to a highway ramp.

### BRIEF DESCRIPTION OF THE DRAWINGS

FIG. 1 is an exemplary diagram illustrating sensors disposed along a road.

FIG. 2A is an exemplary diagram illustrating the sensor value measured by a sensor when a vehicle passes on a road.

FIG. 2B is an exemplary diagram illustrating the sensor value measured by a sensor when a construction work is performed on a road and/or an obstacle is detected.

FIG. 3 is a block diagram schematically illustrating a detection device.

FIG. 4 is a flowchart illustrating a process of detecting when construction work is underway or an obstacle occurs on a road using the detection device.

FIG. 5 is a flowchart illustrating a false detection filtering process.

FIG. 6 is a graph of expected distance measurement values over time when the last lane among multiple lanes is or connects to a ramp.

FIG. 7 is an example diagram of road construction section or obstacle section information generated by the detection device.

FIG. 8 is a block diagram schematically illustrating an exemplary computing device that can be used to implement a method or apparatus.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

Unless otherwise defined, the terms used herein, including technical or scientific terms, may have meanings generally understood by those skilled in the art to which the present disclosure belongs.

The expressions such as "comprise", "may comprise", "include", "may include", "have", "may have", etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as "first" or "second" as used herein are used to distinguish one object from another in referring to multiple similar objects, unless otherwise indicated in context, and do not limit the order or importance between them. For example, a plurality of chips according to the present disclosure may be distinguished from each other by referring them as "first chip", "second chip", respectively.

The expression "based on" as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is "connected" or "coupled" to another component (e.g., a second component) as used herein, it may mean that the component is not only directly connected or coupled to another component, but also connected or coupled through yet another component (e.g., a third component).

Depending on the context, the expression "configured to" as used herein may have meanings such as "set to", "with the ability to", "modified to", "made to", "to be able to", etc. This expression is not limited to the meaning of "specially designed in hardware to". For example, a processor configured to perform a specific operation may refer to a generic purpose processor capable of performing the specific operation by executing software, or to a special purpose computer structured through programming to perform the specific operation.

The term "unit" as used herein may refer to software, or hardware component such as Field-Programmable Gate Array (FPGA), Application Specific Integrated Circuit (ASIC), etc. However, "unit" is not limited to hardware and software. The “unit" may be configured to be stored in an addressable storage medium, or may be configured to execute one or more processors. The "unit" may include components such as software components, object-oriented software components, class components, and task components, as well as processors, functions, attributes, procedures, subroutines, segments of program code, drivers, firmware, microcode, circuits, data, databases, data structures, tables, arrays, and variables.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

One or more controllers described herein may include one or more processors, one or more memory and/or one or more storage devices. One or more controllers of the vehicle may disable operation control of one or more components of the vehicle, based on a result of one or more authentication processes and/or verification processes described herein. The vehicle components may include one or more sensors (e.g., an ultrasound sensor, camera, LIDAR, radar, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, etc.), for example, for autonomous driving control. The vehicle components may also include an auxiliary braking system (e.g., hydraulic retarder, electric retarder), an auxiliary device (e.g., engine brake, exhaust brake, hydraulic retarder, electric retarder, regenerative brake, etc.), a motor, a battery management system, a battery, a communication interface, a controller, a user interface, a key fob, a steering wheel, etc.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, and C", "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., detecting a road construction zone based on analyzing sensor measurement values) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., detecting a road construction zone based on analyzing sensor measurement values) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., detecting a road construction zone based on analyzing sensor measurement values) described herein.

Minimum risk maneuver (MRM) operation(s) may also be controlled, for example, based on one or more features (e.g., detecting a road construction zone based on analyzing sensor measurement values) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., detecting a road construction zone based on analyzing sensor measurement values) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., detecting a road construction zone based on analyzing sensor measurement values) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An operation control for autonomous driving of the vehicle performed based on determining presence of a road construction zone or an obstacle may include, for example, reducing a vehicle speed near or at a road construction zone or an obstacle, taking an alternative route to avoid a road construction zone or an obstacle, updating an estimated time of arrival based on the location and/or length of a section of the road having a road construction zone or an obstacle, notifying (e.g., via a visual or audible alert) a vehicle occupant about presence of a road construction zone or an obstacle, etc.

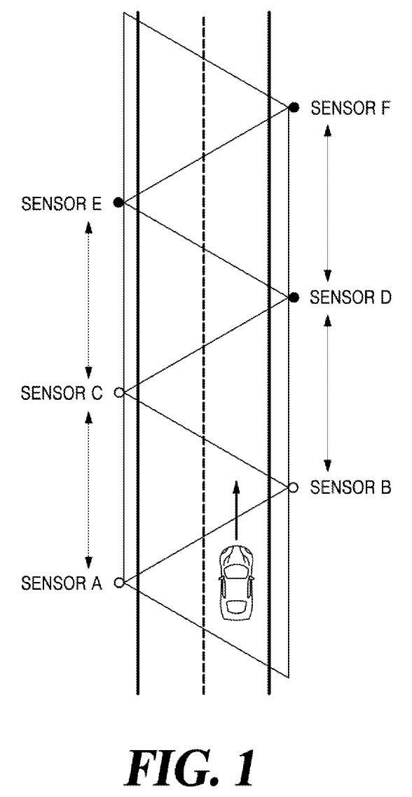

FIG. 1 is an exemplary diagram illustrating disposition of sensors disposed along a road.

Referring to FIG. 1, sensors for detecting road construction may be disposed (e.g., installed) crosswise on, along, or next to a road or a lane. Sensors on the same lane may be installed in series at constant intervals. The sensor may include an ultrasonic sensor. The sensor may transmit a location value of the sensor and a unique sensor identifier (ID) to a control center. The location value of the sensor may include Global Positioning Service (GPS) coordinates. The control center may determine the exact location of the sensor by checking the unique sensor ID.

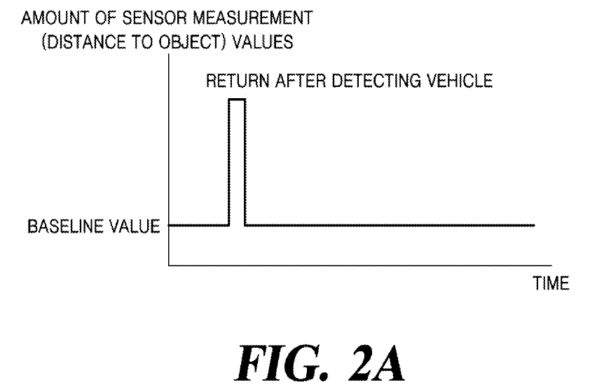

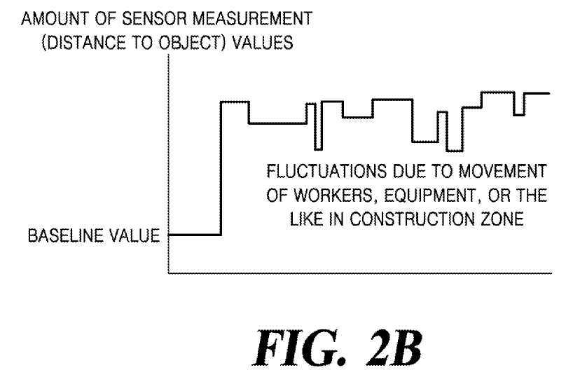

FIG. 2A is an exemplary diagram illustrating the sensor value measured by a sensor when a vehicle passes on a road.

FIG. 2B is an exemplary diagram illustrating the sensor value measured by a sensor when a construction work is performed on a road and/or an obstacle is detected.

In the present disclosure, the sensor value refers to a distance value (e.g., the distance to a measured object) that is measured by an ultrasonic sensor over time. The sensor value may change depending on whether an object such as a vehicle or an obstacle is present within the sensing range of the sensor. Although the sensor value itself represents an absolute distance at each time point, it may be further analyzed to derive a change in distance over time (e.g., a rate of change or a derivative of the distance value). For example, a sudden change in the sensor value may be interpreted as an impulsive event such as a vehicle passing by, whereas a sustained decrease in the sensor value may indicate that a stationary object, such as a construction element or an obstacle, is present.

A "construction section" refers to a sensor-defined portion of the road where a sustained deviation of the sensor value from a baseline value is detected, indicating a likely presence of road construction activity or an obstacle. The section is defined based on sensor data collected over time, and is distinct from a predefined or reported construction zone.

Referring to FIGS. 2A and 2B, the sensor value (representing the distance to an object) varies over time depending on whether a vehicle is passing, construction work is underway, or an obstacle is present. Each scenario results in a different temporal pattern of distance values.

The threshold time duration refers to a minimum time period during which the sensor value remains deviated from the baseline value, indicating a persistent presence of an object such as a construction zone or obstacle. For example, if a sensor value deviates from its baseline and remains deviated for more than a predefined threshold time duration (e.g., 6.3 seconds), the system may determine that a construction zone or obstacle is present, rather than a passing vehicle.

When the vehicle passes by the sensor on the road, the distance measurement value may change very rapidly (e.g., instantaneously). A sudden change (e.g., a rate of change that exceeds a predefined threshold) in the distance measurement value may be determined as (e.g., interpreted as an indicator of) a vehicle, motorcycle, or bicycle passing by. When the vehicle passes on the road, the distance measurement values detected by A, B, C, D, E, and F in FIG. 1. may change sequentially. This sequential variation across the sensors may be used to determine that the object (e.g., vehicle) is passing by.

For example, sensors may be installed on or along a road at regular intervals (e.g., every 10 meters). If, for example, the minimum speed of an object moving on the road is 6 km/h (1.66 m/s), it takes about 6.3 seconds to pass through one sensor. When a vehicle, motorcycle, bicycle, or the like moves on the road at a speed of 6 km/h or more, the time to pass through the sensor is reduced to less than 6.3 seconds. Accordingly, a sharp but short-term deviation in the distance measurement value may be observed on the graph. In the present disclosure, such a temporary variation due to a moving object is called an impulsive change.

Also, peaks will appear sequentially in the graphs of sensors A, B, C, D, E, and F. These sudden changes in sensor values may not be determined as cases of road construction or the occurrence of obstacles, but may be determined as cases of vehicles passing by. For example, momentary fluctuations or sudden spikes in distance measurement values (e.g., when either the values themselves or their rate of change temporarily exceed a threshold variation level for less than or shorter than a threshold time duration) may indicate (e.g., more likely to indicate) a passing vehicle rather than a road construction or an obstacle.

In the case of highway slowdown events (also referred to as traffic slowdown events), such as presence of a construction or an obstacle on the road, a more continuous or gradual movement (e.g., a rise or a fall) in the distance measurement values over time may be detected. If the distance measurement value continues to be at a certain level or higher than a baseline value, it may be determined that construction is occurring on the road or an obstacle occurring. In other words, more sustained fluctuations or movements in the distance measurement values over time (e.g., values or rates of change stay above a threshold variation level for greater than or longer than a threshold time duration) may indicate (e.g., more likely to indicate) a road construction or an obstacle.

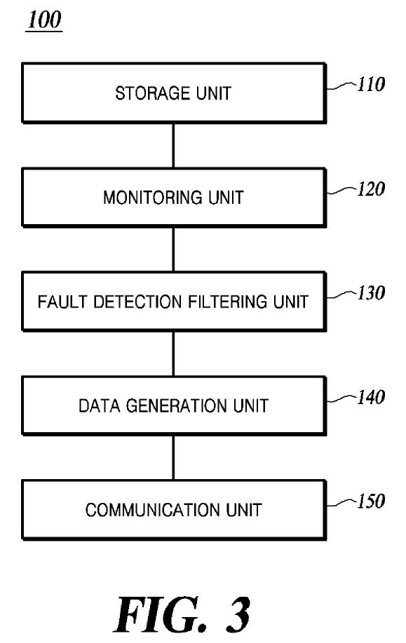

FIG. 3 is a block diagram schematically illustrating a detection device.

As illustrated in FIG. 3, a detection device 100 may include all or part of a storage unit 110, a monitoring unit 120, a false detection filtering unit 130, a data generation unit 140, and a communication unit 150. Not all blocks illustrated in FIG. 1 are essential components, and some blocks included in the detection device 100 may be added, changed, or deleted. Meanwhile, the components illustrated in FIG. 1 represent functionally distinct elements, and at least one of the components may be implemented in a form in which they are integrated with each other in an actual physical environment.

The storage unit 110 may store initial information of distance measurement values acquired from a sensor installed on the road.

The monitoring unit 120 may monitor variations in distance measurement values acquired from sensors installed along the road.

The monitoring unit 120 may determine whether a vehicle is passing on the road, whether construction is underway on the road, or whether an obstacle is present, based on the time of occurrence of a variation in the distance measurement values. The monitoring unit 120 may classify whether the variation corresponds to a passing vehicle, road construction, or obstacle, and store the sensor value in the storage unit 110. The monitoring unit 120 may expand the monitoring range by analyzing data from one or more additional sensors surrounding the sensor section where the sustained variation has been detected (e.g., expanding the monitoring range with sensors outside of the sensor section).

The monitoring unit 120 continuously monitors changes in the sensor value and may determine that construction is complete or an obstacle has been removed when the sensor value returns to a baseline value (also referred to as an initial storage value). The baseline value may be an initial or default sensor measurement value that is registered by the sensor under normal circumstances (e.g., no object is being detected or registered by the sensor).

The false detection filtering unit 130 may determine that, although the sensor data suggests that construction is underway on the road or that an obstacle is present, the situation is actually not one of road construction or obstacle occurrence. In the present disclosure, a case in which construction is underway on the road or an obstacle has occurred based on the variation in distance measurement values, but in reality, the case other than the case where construction is underway on a road or the case where an obstacle has occurred is determined to be referred to as an exceptional case. As an example, the exceptional case may include a case in which a variation in distance measurement values at the road construction level is received due to a malfunction of a sensor. As another example, the exceptional case may include a case in which an impulsive change is received due to a traffic light or traffic congestion. The impulsive change due to a traffic light or traffic congestion may take 6.3 seconds or more for a moving object to pass through the sensor. As another example, the exceptional case may include a case in which a variation in distance measurement values is received due to traffic congestion occurring on a multi-lane road. The traffic congestion on multi-lane roads may include traffic congestion at or around a highway interchange (also referred to as a highway junction). A highway may be a controlled-access highway, and may also be referred to as a freeway, a motorway, an expressway, etc.

In reality, the false detection filtering unit 130 may determine that, although the sensor data suggests that construction is underway or an obstacle is present, the situation is actually not one of road construction or obstacle occurrence, due to false detection by the sensor. As an example, the false detection filtering unit 130 may determine the exceptional case by checking the self-diagnosis result of the ultrasonic sensor. As another example, the false detection filtering unit 130 may determine the exceptional case by using traffic light information at the location of the sensor. As another example, the false detection filtering unit 130 may determine the exceptional case by using traffic information at the location of the sensor. As another example, the false detection filtering unit 130 may determine the exceptional case by using a result value of sensing the distance to an obstacle on a multi-lane road.

The data generation unit 140 may generate section information by defining a sensor section (e.g., a section of a road or a section within the sensor data set) in which a variation in distance measurement values is detected for a long period of time as a road construction section or obstacle section. In other words, the data generation unit 140 may determine, based on rates of change within the plurality of distance measurement values collected from a section of the road being above a first threshold value (e.g., a threshold variation in distance values) for a time duration that is greater than a second threshold value (e.g., a threshold time duration value), a portion of sensor data that indicates presence (e.g., precited present or an elevated likelihood of presence) of a road construction section or an obstacle at the section of the road.

The data generation unit 140 may determine that construction is completed or an obstacle has been removed when the sensor value returns to the baseline value and may generate termination information.

The communication unit 150 may receive a sensor value measured by the sensor of the road. The communication unit 150 may transmit the generated section information to the base station of the road. The base station of the road may transmit the section information received from the communication unit 150 to the vehicle. The vehicle may use the section information to warn the driver or perform evasive traveling to avoid the construction section.

The communication unit 150 may transmit termination information to the road base station when it is determined that construction is completed or an obstacle has been removed when the sensor value returns to the baseline value.

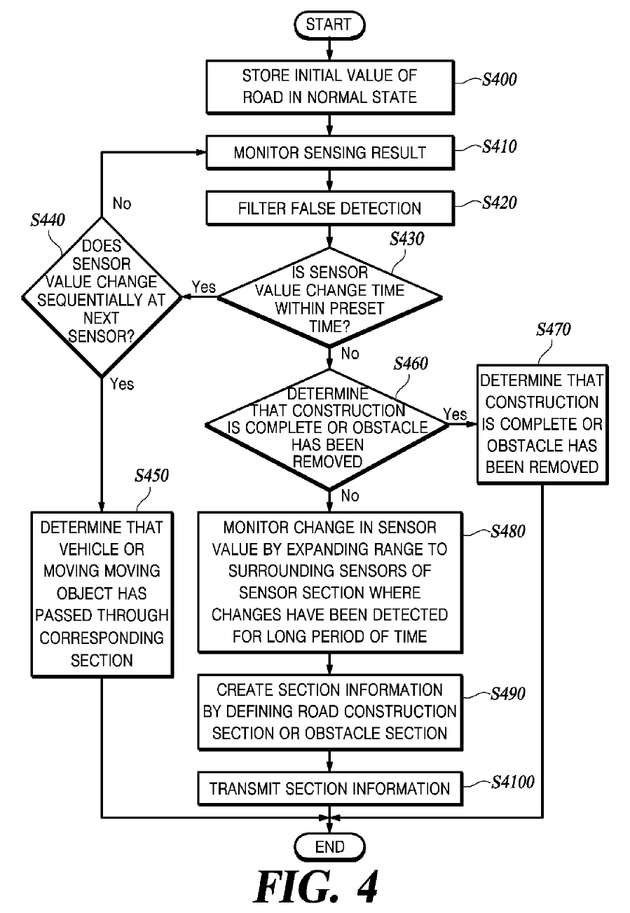

FIG. 4 is a flowchart illustrating a process of detecting when construction work is underway or an obstacle occurs on a road using the detection device.

The detection device 100 may store initial information of the sensor value measured by the road sensor (S400). The initial information of the sensor value may be determined as the initial value of the road in a normal state.

The detection device 100 may monitor changes in sensor values measured from a road sensor (S410).

In reality, the detection device 100 may determine a case other than a case where construction is underway on the road or a case where an obstacle has occurred due to false detection by the sensor (S420).

The detection device 100 may determine whether the variation in distance measurement values persists for a preset time duration (S430). For example, the preset time may be 7 seconds. However, the time setting may vary depending on road conditions, or the like.

The detection device 100 may determine whether the variation occurs sequentially in the next sensor when the variation time is within a preset time (S440).

The detection device 100 may re-monitor a sensing result when the variation does not occur sequentially in the next sensor.

The detection device 100 may determine that a vehicle or moving object has passed through the corresponding section when the variation occurs sequentially in the next sensor (S450).

The detection device 100 may continuously monitor distance measurement values to determine whether the sensor value returns to a baseline value (S460).

The detection device 100 may determine that construction is complete or an obstacle has been removed when the distance measurement values return to the baseline value (S470).

The detection device 100 may expand the monitoring range by analyzing data from surrounding sensors of the sensor section where sustained variation has been detected for a long period of time (S480).

The detection device 100 may create section information by defining a sensor section in which a sustained variation in distance measurement values is detected for a long period of time as a road construction section or an obstacle section (S490).

The detection device 100 may transmit the generated section information to the road base station (S4100).

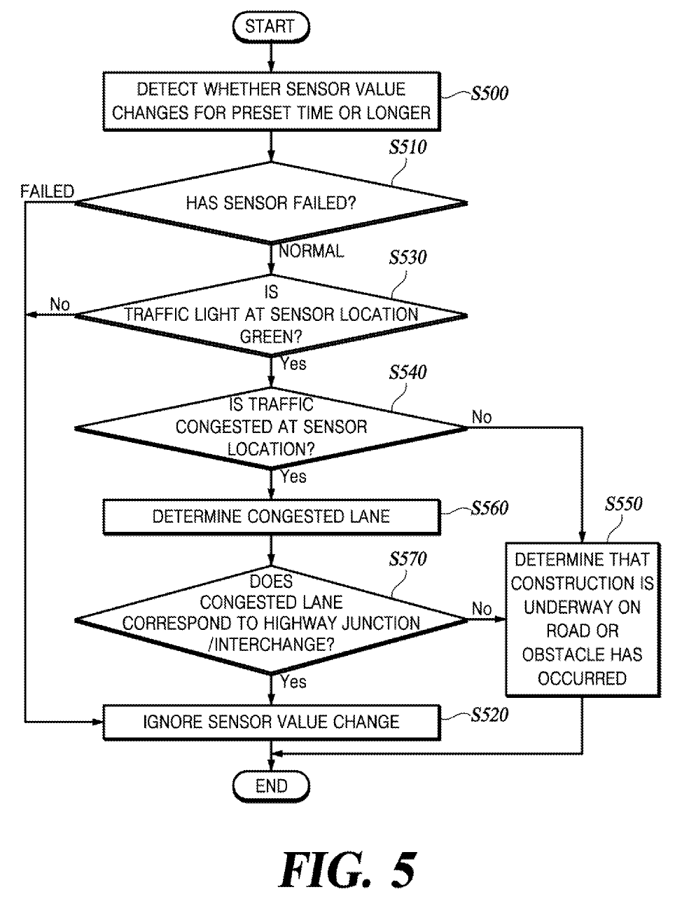

FIG. 5 is a flowchart illustrating a false detection filtering process.

The detection device 100 may detect whether a variation in distance measurement values persists for a preset time or longer (S500). As an example, the preset time may be set to 6.5 seconds. However, the preset time may vary depending on road conditions, or the like.

The detection device 100 may determine whether the variation in distance measurement values at the road construction level has been received due to the sensor failure (e.g., a defect in the sensor) (S510). The detection device 100 may receive national traffic information and real-time traffic light information from a government agency and a CP (Contents Provider). The detection device 100 may map the location of a failed sensor using the national traffic information and real-time traffic light information.

When it is determined that a variation in distance measurement values equivalent to the road construction level has been received due to a sensor failure, the detection device 100 ignores the detected variation (S520).

The detection device 100 may use real-time traffic light information to check whether the traffic light at the sensor location is green (S530).

The detection device 100 may ignore detected variation when it is determined that the traffic light is not green at the sensor location.

The detection device 100 may check national traffic information to determine whether traffic is congested at the sensor location (S540).

If the traffic information at the sensor location is not a traffic jam, the detection device 100 may determine that construction is underway on the road or an obstacle is present (S550).

The detection device 100 may determine whether an impulsive change due to the traffic congestion is received when the traffic information at the sensor location is a congested situation (S560). The detection device 100 may determine a congested lane using the graph of variation in distance measurement values. For example, the detection device 100 may determine the congested lane by checking whether it takes 6.3 seconds or more for a moving object to pass through the sensor by an impulsive change due to the traffic congestion. An ultrasonic sensor may determine the distance to a detection target by using the difference in the time it takes for sound waves to arrive. That is, an ultrasonic sensor may identify a lane where congestion occurs by using the difference in the time it takes for sound waves to arrive at each lane.

The detection device 100 may determine whether the congested lane corresponds to or connects to a ramp (e.g., an onramp or an offramp for a highway interchange) (S570). If the congested lane is not a ramp (e.g., or if the congested lane does not connect to a ramp), the detection device 100 may determine that construction is underway or an obstacle is present on the road. If the congested lane corresponds to or connects to a ramp (e.g., an onramp or an offramp for a highway interchange), the detection device 100 may ignore the variation in the distance measurement values.

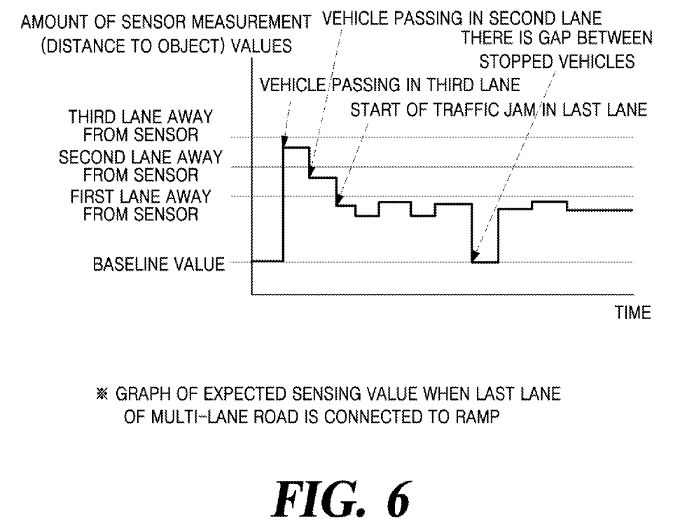

FIG. 6 is a graph of expected distance measurement values over time when the last lane among multiple lanes is or connects to a highway ramp (e.g., an onramp to or offramp from a junction or an interchange).

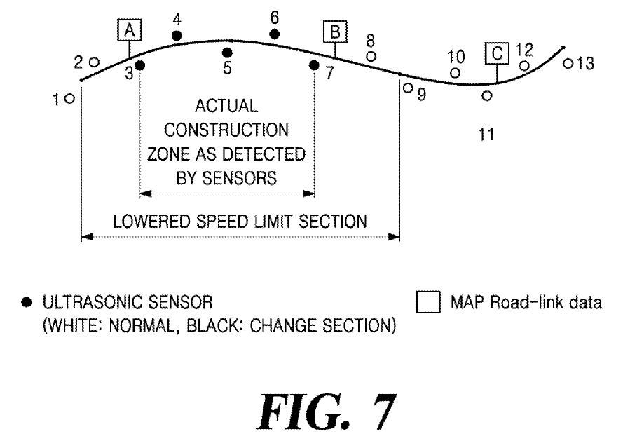

FIG. 7 is an exemplary diagram of road construction section or obstacle section information generated by the detection device.

The detection device 100 may define the sensor section in which a sustained variation in distance measurement values is detected for a long period of time as a road construction section or obstacle section and generate section information.

The detection device 100 may map the locations of sensors installed on the road and map data of the road. The detection device 100 may generate information on the road construction section or obstacle section using map data on which the locations of sensors are mapped.

Referring to FIG. 7, the numbers on the drawing represent sensors installed on the road. For example, each number represents one sensor. Road link data represents geographical data of individual roads that make up a road network.

The detection device 100 may determine that the sensors at both ends of the sensor section in which a sustained variation in distance measurement values is detected for a long period of time are actual road construction sections. For example, referring to FIG. 7, the detection device 100 may determine that the sensors at both ends (sensors 3 and 7) of the sensor section (sensors 3, 4, 5, and 6) are actual road construction sections.

The detection device 100 may designate a load link section including the sensor section in which a sustained variation in distance measurement values is detected for a long period of time as a safe driving guidance section. For example, referring to FIG. 7, the detection device 100 may designate the load link section including the sensor sections (sensors 3, 4, 5, and 6) as the lowered speed limit section (sections A and B). The detection device 100 may use the lowered speed limit section to provide accurate information on which road to drive safely on due to construction. A vehicle passing on a road may use the lowered speed limit section to slow down before entering the road or to travel while avoiding a road under construction.

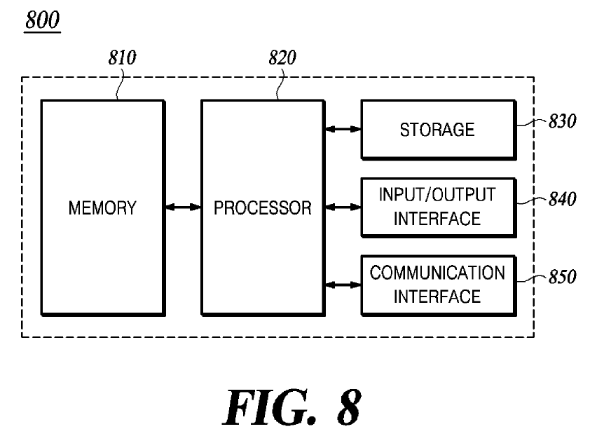

FIG. 8 is a block diagram schematically illustrating an exemplary computing device that can be used to implement a method or apparatus according to the present disclosure.

A computing device 800 may include some or all of a memory 810, a processor 820, a storage 830, an input/output interface 840, and a communication interface 850. The computing device 800 may structurally and/or functionally include at least a portion of the detection device 100. The computing device 800 may be a stationary computing device, such as a desktop computer or a server, as well as a mobile computing device, such as a laptop computer, a smart phone, an automotive electronic device, and the like. The computing device 800 may be implemented with any specialized hardware accelerator capable of efficiently processing operations for an artificial intelligence model. For example, the computing device 800 may include a graphic processing unit (GPU), a tensor processing unit (TPU), or a neural processing unit (NPU).

The memory 810 may store a program (e.g., instructions) that causes the processor 820 to perform a method or operation as described here. For example, the program may include a plurality of commands (e.g., instructions) executable by the processor 820, and the above-described method or operation may be performed by executing the plurality of commands by the processor 820. The memory 810 may be a single memory or a plurality of memories. In this case, information necessary for performing the method or operation may be stored in a single memory or may be divided and stored in a plurality of memories. When the memory 810 includes a plurality of memories, the plurality of memories may be physically separated. The memory 810 may include at least one of a volatile memory and a nonvolatile memory. The volatile memory includes a static random access memory (SRAM) or a dynamic random access memory (DRAM), and the nonvolatile memory includes a flash memory or the like.

The processor 820 may include at least one core capable of executing at least one command. The processor 820 may execute commands stored in the memory 810. The processor 820 may be a single processor or multiple processors.

The storage 830 maintains stored data even when power supplied to the computing device 800 is cut off. For example, the storage 830 may include nonvolatile memory, and may include storage media such as a magnetic tape, an optical disk, or a magnetic disk. A program stored in the storage 830 may be loaded into the memory 810 before being executed by the processor 820. The storage 830 may store a file written in a programming language, and a program generated from the file by a compiler or the like may be loaded into the memory 810. The storage 830 may store data to be processed by the processor 820 and/or data processed by the processor 820.

The input/output interface 840 may provide an interface with an input device such as a keyboard, mouse, or the like and/or an output device such as a display device, printer, or the like. A user may trigger execution of a program by the processor 820 through an input device and/or check the processing result of the processor 820 through an output device.

The communication interface 850 may provide access to an external network. The computing device 800 may communicate with other devices through the communication interface 850.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A method comprising:
receiving, by at least one processor from a sensor disposed along a road, one or more sensor values measured by the sensor;
storing the one or more sensor values in memory;
monitoring, based on the one or more stored sensor values, a variation in distance over time;
determining, based on a change in the one or more sensor values, that no road construction or obstacle has been detected;
defining a sensor section, where the change in the one or more sensor values has been detected for a longer than a threshold time duration, as a road construction section or an obstacle section and generating, based on the defined sensor section, section information; and
transmitting, to a base station, the section information via a wireless transceiver.

2. The method of claim 1, wherein the monitoring comprises determining, based on a time of the change, whether a vehicle is passing on the road or whether a road construction or an obstacle is present on the road.

3. The method of claim 1, wherein the monitoring comprises expanding a monitoring range by additionally monitoring with one or more sensors outside of the sensor section.

4. The method of claim 3, wherein the one or more sensors outside of the sensor section comprises at least one of:
one or more sensors disposed along the road; or
one or more vehicles traveling on the road.

5. The method of claim 1, wherein the monitoring comprises determining, based on the one or more sensor values returning to a baseline value of the sensor, that the road construction is complete or the obstacle is removed.

6. The method of claim 5, further comprising:
based on the one or more sensor values returning to the baseline value of the sensor, transmitting, to the base station, an indication of completion of the road construction or removal of the obstacle.

7. The method of claim 1, wherein the determining comprises determining whether a variation in the one or more sensor values indicating presence of the road construction is due to a failure of the sensor.

8. The method of claim 1, wherein the determining comprises determining whether a variation in the one or more sensor values is due to a traffic light or a traffic congestion.

9. The method of claim 1, wherein the determining comprises determining whether a congested lane of the road corresponds to a highway ramp.

10. An apparatus comprising:
at least one processor; and
memory storing instructions that, when executed by the at least one processor, cause the apparatus to:
receive, from a sensor disposed along a road, a one or more sensor values measured by the sensor;
store, in the memory, the one or more sensor values;
monitor, based on the one or more stored sensor values, a variation in distance over time;
determine, based on a change in the one or more sensor values, that no road construction or obstacle has been detected;
define a sensor section, where the change in the one or more sensor values has been detected for longer than a threshold time duration, as a road construction section or an obstacle section and generate, based on the defined sensor section, section information; and
transmit, to a base station, the section information via a wireless transceiver.

11. The apparatus of claim 10, wherein the instructions, when executed by the at least one processor, cause the apparatus to monitor the change by determining, based on a time of the change, whether a vehicle is passing on the road or whether a road construction or an obstacle is present on the road.

12. The apparatus of claim 10, wherein the instructions, when executed by the at least one processor, cause the apparatus to monitor the change by expanding a monitoring range by additionally monitoring with one or more sensors outside of the sensor section.

13. The apparatus of claim 12, wherein the one or more sensors outside of the sensor section comprises at least one of:
one or more sensors disposed along the road; or
one or more vehicles traveling on the road.

14. The apparatus of claim 10, wherein the instructions, when executed by the at least one processor, cause the apparatus to monitor the change by determining, based on the one or more sensor values returning to a baseline value of the sensor, that the road construction is complete or the obstacle is removed.

15. The apparatus of claim 14, wherein the instructions, when executed by the at least one processor, further cause the apparatus to:
based on the one or more sensor values returning to the baseline value of the sensor, transmit, to the base station, an indication of completion of the road construction or a removal of the obstacle.

16. The apparatus of claim 10, wherein the instructions, when executed by the at least one processor, cause the apparatus to determine that no road construction or obstacle has been detected, by:
determining whether a variation in the one or more sensor values indicating presence of the road construction is due to a failure of the sensor.

17. The apparatus of claim 10, wherein the instructions, when executed by the at least one processor, cause the apparatus to determine that no road construction or obstacle has been detected, by:
determining whether an amount of the change in the one or more sensor values is due to a traffic light or a traffic congestion.

18. The apparatus of claim 10, wherein the instructions, when executed by the at least one processor, cause the apparatus to determine that no road construction or obstacle has been detected, by:
determining whether a congested lane of the road corresponds to a highway ramp.
